(19) United States
(12) Patent Application Publication
(10) Pub. No.: US 2026/0077387 A1
(43) Pub. Date: Mar. 19, 2026

(54) Method and Apparatus for Curing Varnish

(71) Applicant: JFL-Materials GmbH, Ludwigshafen (DE)

(72) Inventors: Matthias Leidel, Bensheim (DE); Simon Horoz, Weilerbach (DE)

(21) Appl. No.: 19/108,177

(22) PCT Filed: Aug. 31, 2023
(86) PCT No.: PCT/EP2023/073963

§ 371 Date: Mar. 3, 2025

(30) Foreign Application Priority Data
Sep. 7, 2022 (EP) 22194476.2

(51) Int. Cl. B05D 3/06; B05D 1/28; B05D 1/40

(52) U.S. Cl. CPC B05D 3/067; B05D 1/28; B05D 1/40

(57) ABSTRACT

The invention relates to a method for curing UV varnish (3), which is applied to the surface of a substrate (2), using a roller (7), the roller core (8) of which holds at least one UV radiating-emitting UV source (10), in which method the UV radiation penetrates a roller coating (9) surrounding the periphery and strikes the surface coated with the UV varnish (3).

### CROSS REFERENCE TO RELATED APPLICATIONS

This application is the U.S. national stage of International Application No. PCT/EP2023/073963, filed on 2023-08-31. The international application claims the priority of EP 22194476.2 filed on 2022-09-07; all applications are incorporated by reference herein in their entirety.

### BACKGROUND

The invention relates to a method for curing UV varnish using a roller, and apparatus therefor.

In varnishing technology or lacquering technology, the curing of varnishes using ultraviolet (UV) radiation is becoming increasingly important. UV-curing varnishing systems, also referred to hereafter as UV varnishes, have a relatively high mechanical and chemical resistance and can be cured within a relatively short time—for example, within a few seconds. Furthermore, the energy required for curing in UV-curing varnishing systems is significantly lower than that required for thermally curing varnishing systems, and the UV-curing varnishing systems can be easily formulated without solvents.

With these properties, UV varnishes have begun their triumphal advance—for example, in the furniture industry and in web-type substrates or components. UV varnishes are also increasingly being used for coating metal.

Since uniform irradiation with UV light is very advantageous for the curing of UV varnishes, the applications are currently substantially limited to the coating of flat substrates and/or substrates with relatively simple geometry. The substrates or components can, for example, be sheets or panels or the like made of metal, wood, stone, cardboard, or other materials to be coated.

When UV varnishes are cured, the UV light splits the photoinitiators of the UV varnishes into radicals, which in turn polymerize the double bonds in a chain reaction. The reaction proceeds quickly, but is disrupted at the interface with the ambient air by oxygen molecules that act as radical scavengers. To counteract this, a relatively strong dose of UV light and photoinitiators is used so that the varnish is sufficiently cross-linked and “tack-free”even on the surface.

Mercury vapor lamps are often used as UV sources, and their spectrum can be adapted to requirements by doping. Electron beam machines and X-ray machines have not been widely adopted, for occupational health reasons and due to the high acquisition costs. For a number of years now, UV LED emitters have also been used, which have low energy requirements and work without the use of mercury. UV LED emitters have the disadvantage that they produce longer-wave UV light, and oxygen inhibition is currently problematic. Only reactive varnish systems can be cured with LED emitters, or the curing takes place under an inert gas or at very short distances.

Particularly from the point of view of possible energy savings, it would be very advantageous to increasingly switch the curing process from mercury vapor lamps to LED emitters. Mercury vapor lamps generate a broad spectrum of electromagnetic radiation, only a small part of which is needed to activate the photoinitiator. LED emitters can produce radiation of the desired wavelength much more selectively. While a conventional curing process often requires 100-200 W per cm of lamp length, with an LED lamp, a radiation of 4-8 W per cm can be sufficient. This is especially the case if the curing reaction can be carried out in the absence of oxygen. For a curing system with a typical working width of 130 cm, the energy requirement is 13-26 KW using conventional lamp technology. In the example, the energy requirement for generating the radiation would be 0.5-1 kW.

DE 10 2013 215 739 A1 and GB 2 576 922 A each disclose rollers formed by a rotatable, transparent, and hollow cylinder, inside of which the actual light source is fixed.

DE 101 44 579 C2 discloses a method for producing fine-to microstructures and/or complex microsystems by layer-by-layer construction in and from a photocurable liquid between two boundary surfaces, wherein the individual layers are formed by exposing the liquid through a mask corresponding to the layer topography, and the distance between the boundary surfaces is successively increased by the respective layer thickness, as well as an apparatus for carrying out the method. The individual layers of the structure to be built up are generated between two opposing, counter-rotating rollers of a roller pair that form the boundary surfaces, and the roller spacing of the rollers of the respective roller pair is determined by the thickness of the layer to be formed and the thickness of the layers already present, wherein the first layer is applied to a substrate carrier film that passes between the rollers. Each roller of the roller pair is designed as an exposure roller and consists of a material that is permeable to electromagnetic waves, wherein, in this exposure roller, there is arranged an electromagnetic wave-emitting source in the form of a light source, and wherein the surface of the exposure roller is non-adhesive. In particular, the arrangement of the light source in the rotating exposure roller is in practice relatively complex to implement.

Furthermore, the document EP 1 667 836 B1 describes a tool and a method for producing a microstructured surface, wherein a die with a negative of the microstructure to be produced and a pressure roller that can be moved over a surface for pressing the die onto the surface are present. The die is arranged in such a way that, when the roller moves over the surface, the die enters into a rolling movement between the roller and the surface, so that the negative of the die faces the surface. An apparatus for accelerating the curing of a curable material comprising a light and/or heat source for irradiating and/or heating the microstructurable surface is arranged such that, as the pressure roller moves over the surface, the apparatus accompanies the roller's movement and acts upon a part of the surface. The light and/or heat source is located inside the pressure roller and is mounted in such a way that the energy emitted by it can be transferred through the pressure roller material to the die (in the case of heat) or can radiate through the die (in the case of light). In the latter case, the roller material must have a high transmittance for the wavelength emitted by the light source.

EP 1 951 436 B1 discloses a “calendering process” with through-curing through a film in order to produce a structured surface. The problem here is the edge regions of the coated plate, which have to be trimmed.

### SUMMARY

The invention relates to a method for curing UV varnish (3), which is applied to the surface of a substrate (2), using a roller (7), the roller core (8) of which holds at least one UV radiating-emitting UV source (10), in which method the UV radiation penetrates a roller coating (9) surrounding the periphery and strikes the surface coated with the UV varnish (3).

### DETAILED DESCRIPTION

The invention addresses the problem of creating a method and an apparatus of the type mentioned at the outset, which ensures reliable curing of UV varnish on a substrate with relatively low equipment outlay.

According to the invention, the object is achieved by the features of the independent claims.

The dependent claims represent advantageous embodiments of the invention.

In a method for curing UV varnish, which is applied to the surface of a substrate, using a roller, the roller core of which holds at least one UV radiation-emitting source, wherein the UV radiation penetrates a roller coating surrounding the periphery and strikes the surface coated with the UV varnish.

An apparatus for carrying out the method comprises a roller which comprises a central roller core and a peripheral roller coating, wherein the roller core holds a plurality of UV sources distributed over the circumference, the emitted UV radiation of which penetrates the roller coating permeable to UV radiation and strikes the surface of the substrate coated with the UV varnish in order to cure the UV varnish.

In a first step, UV varnish is applied to the substrate or component surface. This coating can be carried out in a rolling process, casting process, spraying process, with a doctor blade or the like in one or more steps. The substrate is conveyed or transported using a suitable transport device. For example, the roller or a counter roller arranged opposite the roller can be driven in order to convey the substrate. The direction of movement of the substrate and the roller can be the same, wherein the speeds of the substrate and the roller can be the same or different.

Due to the contact pressure of the roller or the roller coating on the surface of the substrate, the roller coating forms on its rolling line a surface-the so-called roller nip—parallel to the substrate. The initially uncured UV varnish is located between the substrate and the roller coating. A small bead of liquid UV varnish forms at an inlet edge between the substrate and the roller coating and grows until the amount of varnish delivered with the substrate corresponds to the amount of varnish transported under the surface of the roller coating. The size of the resulting varnish bead depends substantially upon the viscosity of the UV varnish, the contact pressure of the roller or the roller coating on the surface of the substrate, and the speed gradient between the roller and the substrate. In addition, the nature of the roller coating and the substrate have an influence on the bead formation.

The UV varnish, which is located between the substrate and the roller coating, is cured with UV radiation during the transport of the substrate. For this purpose, the UV radiation source or the UV radiation is aligned with the roller core, preferably attached in its peripheral circumferential surface, in such a way that the UV radiation penetrates the roller coating and strikes the UV varnish in order to cure the UV varnish. It is of course possible to arrange optical elements for bundling or orienting the UV radiation emanating from the UV source, wherein these optical elements can be assigned to the roller core and/or the roller coating without departing from the scope of the invention.

Because the curing process takes place without contact with oxygen from the ambient air, i.e., there is no oxygen inhibition, the degree of cross-linking on the surface is relatively high, which enables positive mechanical and chemical properties of the varnish surface to be achieved. After the UV-induced polymerization, the workpiece, i.e., the substrate with the cured varnish, is released again by the transport, thus leaving the region of the roller, and excess varnish, which has built up in small amounts in the direction of travel on the sides of the substrate edge and on the run-out edge, remains attached to the workpiece as a burr. Due to the return movement of the roller coating, the varnish separates relatively easily from the roller surface. This is supported by the choice of a suitable coating material (e.g., silicone with an E-modulus of about 8 MPa) and, if necessary, a surface treatment of the roller. If high-quality optical and very uniform surface structures are to be achieved on the substrate, it is important that no hardened varnish material adhere to the roller. If necessary, a scraper can be provided to remove such adhering varnish residues from the roller coating.

LED emitters with radiation in a spectral range between 365 nm and 390 nm, which are currently commercially available, can be used as UV sources. Other wavelength ranges are also possible. At 365-390 nm, this radiation penetrates relatively deeply into the cured varnish material. A person skilled in the art selects the preferred emitter according to the formulation of the UV varnish. The LED UV emitters are conveniently arranged distributed over the length and periphery of the roller core.

When coating rigid, plate-shaped material, the method described here has the advantage, for example, that defects in the edge region, which are common in methods using the calendering process known from the prior art, do not occur or at least occur to a reduced extent, since a uniform pressure is applied to the polymerization mixture, i.e., the UV varnish, over the entire width of the roller, and there is no “slipping” of the film in the edge region, which leads to defects there.

The roller core must be mechanically stable enough to allow the contact pressure on the counter roller or the conveyor belt and to be able to absorb the force required to rotate the roller. Furthermore, the roller core should advantageously have reflective properties, in order to reflect scattered light to the roller surface, i.e., to the surface of the roller coating. The roller core can be made of metal such as iron, steel, aluminum, or metal alloys such as brass. For more pressure-sensitive substrates and small rollers, plastics can also be used to manufacture the roller core.

The roller coating should have good permeability for the UV radiation necessary to initiate the polymerization reaction. A low optical density of the material can have a positive effect, since it can be advantageous if the radiation transfer from the roll coating into the polymerization mixture takes place in the optically denser medium. In addition, the roller coating must have a certain elasticity that allows the formation of a roller nip, so that the cross-linking reaction can take place underneath it. For easy separation of the cured varnish from the roller surface, good mechanical deformability and rapid recovery to the original shape are also advantageous. Adhesions of varnish material on the roller lead to a deterioration in the quality of the coating.

The UV emitters can be arranged as an intermediate layer between the roller core and the roller coating. They can also be integrated into the roller core or into the roller coating. The UV emitters should be distributed as evenly as possible across both the periphery and the width of the roller. If an uneven radiation distribution is necessary for technical reasons, this specification can be deviated from.

In their design, the UV emitters or UV sources are switchable and are only supplied with voltage when the emitted radiation takes the direct path from the UV emitter through the roller coating into the polymerization mixture located under the roller nip. For position-dependent voltage supply, either an electronic controller switches the voltage supply of certain UV sources on and off depending upon signals from a position detection sensor, or current paths of the UV sources arranged in a row and interconnected are connected to a contact assigned to the end face of the roller, which contact acts upon a voltage-carrying contact segment to open and close an electric circuit.

Preferably, a row of UV sources extending across the width of the roller core is integrated into a light segment that can be exchangeably attached to the roller core. After reaching the end of their service life or if they are otherwise damaged, individual light segments can be replaced, especially after the roller coating has been removed.

A cooling device is assigned to the roller to dissipate process heat. For example, the roller core can have cooling holes or the like through which a coolant flows.

Preferably, the roller coating of the roller is elastic. Depending upon the contact pressure of the roller on the substrate coated with UV varnish, a more or less large contact surface is formed. Ideally, the roller coating has a Shore A hardness between 30 and 60. The roller coating is therefore designed to be relatively soft. Furthermore, the roller coating can be arranged on the roller core in an exchangeable, in particular reversibly exchangeable, manner. This means that different structures of the cured UV varnish can be created using different roller coatings, and, if the roller coating becomes worn, it can be replaced. To create surface effects in the varnished surface, the roller coating either is smooth or has a surface structure. The nature of the surface of the roller coating is used to create surface structures of the varnish coating, since the surface structure of the roller is reflected on the varnish surface. For example, a smooth surface of the roller coating creates a high-gloss surface of the finished component, i.e., the coating or UV varnish, and, depending upon the surface structure, different degrees of gloss, structures, or effects such as anti-fingerprint properties can be achieved.

The roller coating can have a thickness of 2% to 80%, preferably 10% to 20%, of the radius of the roller.

In order to convey the substrate and to determine a layer thickness of the UV varnish on the substrate, according to a development of the invention, an adjustable counter roller is assigned to the roller, wherein the substrate coated with the UV varnish can be conveyed between the roller and the counter roller. Of course, the roller and the counter roller are mounted in a frame and, if necessary, connected to drives that enable both a rotational movement and a linear feed movement of the counter roller relative to the roller. The counter roller ensures that the substrate coated with UV varnish is pressed against the roller with the necessary pressure. The distance between the substrate and the roller must be set such that the roller coated with the roller coating is at least 1% of the thickness of the roller coating and at most 20% of the thickness of the roller coating, preferably between 3% and 10% of the thickness of the roller coating, compared to the distance between the substrate and the unloaded roller.

The pressure of the roller is evenly distributed over the entire surface of the substrate and does not separate from the substrate even in the edge regions, which reduces the risk of defects in the varnished surface. Furthermore, no defective edge regions need to be removed. Therefore, already formatted substrates can be coated.

The edges, or at least the curve at the edge, are minimally coated by the pressing in of the curing roller. This offers advantages when coating panels with glued edges. Such panels are often used in the furniture industry. Because the adhesive seam is sealed from above with the top coat, the workpieces varnished in this way are much better protected against moisture penetration. Any protruding burr of coating material on the vertical edge can be easily removed mechanically using an apparatus.

Expediently, the UV source is designed as an LED UV emitter. The LED UV emitter is energy efficient and ensures that the system heats up relatively little. Of course, other radiation sources for UV light can also be used without departing from the scope of the invention.

Furthermore, for deep curing or post-cross-linking of the UV varnish, a light source emitting light radiation is provided, the light radiation of which can be directed onto the substrate, the surface of which is coated with the cured UV varnish.

If the UV source or the LED UV emitters are located on the surface of the roller, i.e., the peripheral circumferential surface of the roller core directly beneath the roller coating, the majority of the radiation is directed towards the UV varnish to be cured, and the loss of intensity is relatively low compared to a rod-shaped or point-shaped radiation source that is centrally mounted in the roller. Furthermore, heat is dissipated from the UV source via the roller core, and each of the UV sources is only active for a certain time, during which it occupies a position in which the radiation strikes the UV varnish, and can cool down during the remaining inactive time. Any roller circumference is possible, because the radiation sources can be mounted relatively close to the roller surface.

It is understood that the features mentioned above and still to be explained below can be used not only in the respectively specified combination, but also in other combinations. The scope of the invention is defined only by the claims.

The invention is explained in more detail below on the basis of an exemplary embodiment with reference to the associated drawings.

### BRIEF DESCRIPTION OF THE DRAWINGS

In the Drawings:

FIG. 1 is a schematic representation of an apparatus for coating a surface of a substrate with a UV varnish, i.e., for carrying out a varnishing process,

FIG. 2 is a schematic side view of an alternative roller according to detail II of FIG. 1

FIG. 3 is a schematic perspectival representation of the roller according to FIG. 2,

FIG. 4 is a further side view of the roller according to FIG. 2,

FIG. 5 is a schematic front view of the roller according to FIG. 4, and

FIG. 6 is a further side view of the roller according to FIG. 2.

### DETAILED DESCRIPTION OF THE PREFERRED EMBODIMENTS

The apparatus substantially comprises a conveyor belt 1, which can also be replaced by one or more counter rollers and substantially serves to support and convey a substrate 2, wherein the substrate is a substantially plate-shaped or belt-shaped component or workpiece, the surface of which is to be coated with a UV varnish 3. In a first step, the UV varnish 3 is applied to the surface of the substrate 2 from a storage container 6 at a coating station 4 by means of a rotating coating roller 5.

In a second step, the UV varnish 3 is cured using UV radiation. For this purpose, a roller core 8 of a roller 7, which further comprises a peripheral roller coating 9 that is permeable to UV radiation, is equipped with UV sources 10 designed as LED UV emitters 11.

In a third step, the UV varnish 3 cured on the surface of the substrate 2 is deep-cured using a conventional emitter 12, which in the present case can be designed as an energy-saving LED emitter 13 with radiation in a spectral range between 365 nm and 390 nm. This deep curing is not necessary in every case, but depends upon the UV source 10 used, the UV varnish 3 used, and other manufacturing or process parameters such as, in particular, the process speed.

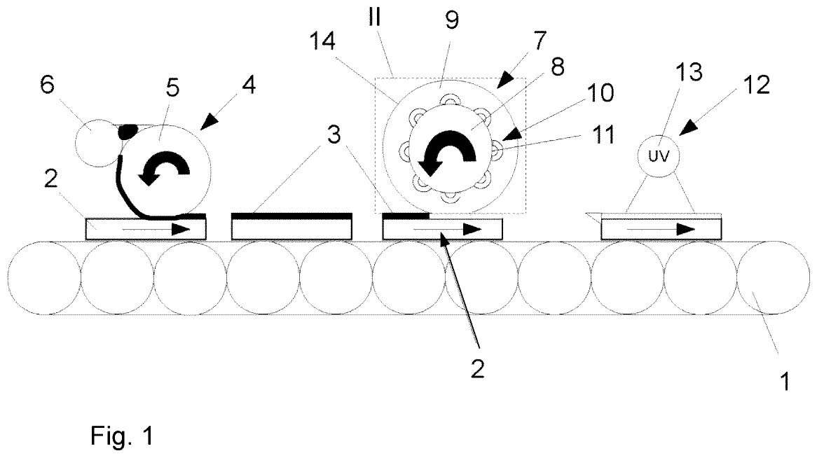

The LED UV emitters 11 can be distributed over the periphery of the roller core 8 of the roller 7 and can extend, for example, in a net-like manner over the peripheral surface, as indicated in FIGS. 1 and 3.

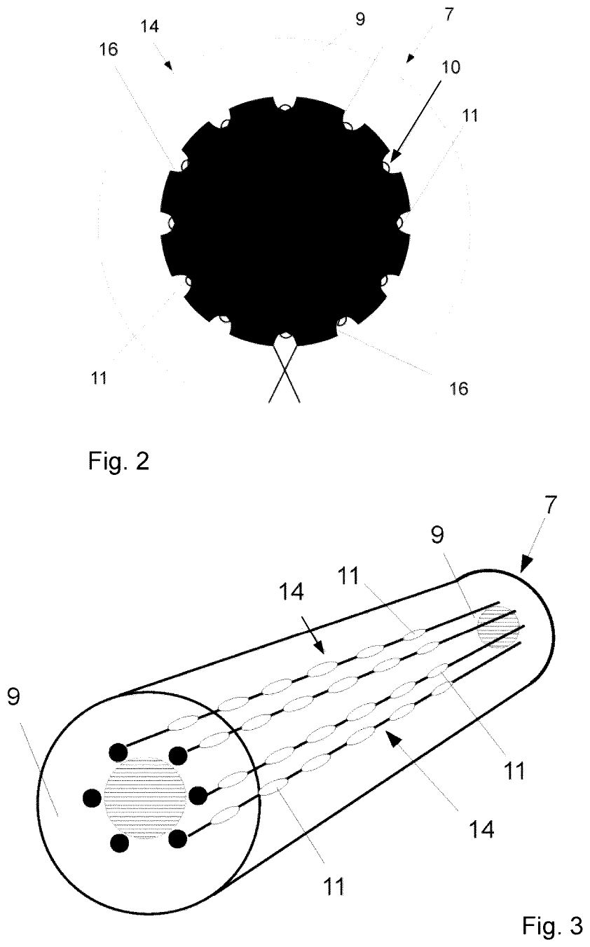

Alternatively, the UV sources 10 designed as LED UV emitters 11 can be inserted into groove-like recesses 16 which extend over the periphery of the roller core 8 and across the width of the roller 7. The recesses 16 may have a reflective surface and a geometry that focuses the UV radiation, as shown in FIGS. 2 and 3. In this case, it is possible to integrate the LED UV emitters 11, for example, into a pouring compound and to combine them to form a light segment 17, wherein the light segment 17 is exchangeably fastened in the associated recess 16. The channel-like recesses 16 can be filled with various media, e.g., liquids or gases, wherein these media must be as permeable as possible to UV radiation and should have an advantageous optical density. In addition, the media can serve as heat carriers and dissipate unwanted process heat.

If the LED UV emitters 11 are arranged on the surface of the roller core 8 or in the recesses 16 of the roller core 8, the heat generated during the radiation emission can be dissipated via the rear side of the LED UV emitters 11 via the metallic roller core 8 or the media present in the recesses 16. It is also possible to equip the roller core 8 with cooling holes for a water cooling system, which is coupled to a cooling device in a manner familiar to a person skilled in the art. By dissipating the heat of the LED UV emitters 11, heating of the LED UV emitters 11 that would lead to functional limitations is avoided, and a relatively high radiation output or a low wavelength of UV radiation can also be achieved, wherein lower wavelengths can represent an advantage, due to higher energy contents when curing the UV varnish 3.

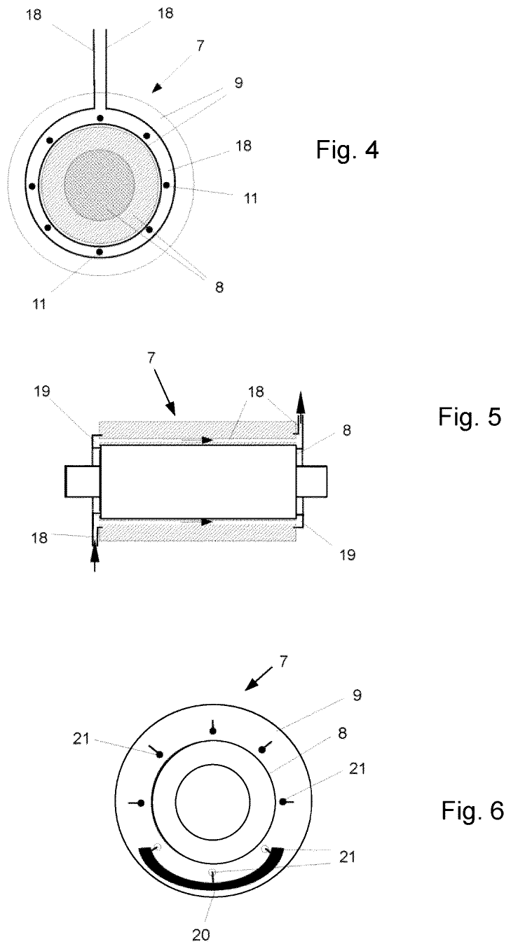

The cooling media flow through an annular line 18, as indicated in FIGS. 4 and 5, which is sealed against the roller 7 by means of end-face slip ring seals 19 in order to provide an inlet and outlet.

The control of the UV sources 10, which are advantageously only supplied with voltage when they are aligned in the direction of the substrate 2, i.e., a relatively direct radiation path is provided, is carried out by an electronic controller with which the position can be detected, or an arrangement of a voltage-carrying contact segment 20 shown in FIG. 6, which is acted upon by the LED UV emitters 11 or contacts 21 assigned to light segments 17 in order to close electric circuits, depending upon the rotational position of the roller 7. An electric circuit is only closed to supply energy to the LED UV emitters 11 when the light segments 17 with the associated contacts 21 are located in the region of the arc-shaped contact segment 20. This makes it possible to switch the LED UV emitters 11 on and off sequentially, which saves electrical energy and reduces heat generation.

The roller coating 9, which is permeable to UV radiation, of the roller 7 has a thickness of approximately 2% to 80%, preferably between 10% and 20%, of the radius of the roller 7 and has an elasticity, for example, with a hardness between 30 and 60 Shore A.

The roller coating 9 can consist of various materials that are transparent to UV radiation, wherein a low extinction coefficient is advantageous in order to achieve a high radiation intensity. For example, elastic polyurethane materials, silicone rubbers, or other transparent elastic rubbers can be used, which preferably do not contain any fillers that increase the extinction coefficient.

The LED UV emitters 11 assigned to the roller core 8 can be directly enclosed by the roller coating 9. Then, the beam path can pass from the LED UV emitter 11 directly into the roller coating 9 without additional material transfer. This structure can be easily realized by fixing the LED UV emitters 11 to the roller core 8 and pouring the roller coating 9 around them.

Alternatively, the roller coating 9 consisting of a silicone rubber mixture can be applied to the roller core 8 in a plurality of layers, for example, wherein a relatively elastic layer with very good adhesion to the roller core 8 is applied in a coating process, then the roller 7 pre-coated in this way is transferred to a casting mold, and the majority of the silicone rubber is cast with a type that has advantageous mechanical properties with regard to elasticity and durability. In order to minimize the adhesion of the UV varnish 3 to the roller coating 9, the latter can be subjected to surface treatments, or a release agent can be used during the manufacture of the roller 7.

In a further alternative embodiment, the roller coating 9 can also be formed in such a way that it is completely or partially exchangeable. This means that different surface structures can be created as required, without having to have different rollers 7 available. In addition, worn roller coatings 9 can be exchanged without having to manufacture a completely new roller 7.

The roller coating 9 can be formed in such a way that, after its removal, the individual LED UV emitters 11 or light segments 17 are accessible in order to enable exchange if necessary. The roller coating 9 can, for example, be formed as a type of cover that can be pushed over the roller core 8. An axial fixation of the roller coating 9 can preferably be carried out on the end faces of the roller 7 with appropriate holders. For radial fixation, the roller coating 9 can be provided with protrusions or extensions or the like, which engage in corresponding recesses in the roller core 8. When the roller coating 9 is pulled onto the roller core 8, the roller coating 9 can be elastically stretched so that it also rests against the roller core 8 in a pre-tensioned manner.

Of course, the roller coating 9 can be provided on its peripheral surface 14 with a structure which is produced by subsequent processing or by a casting process in which the structure of the die is incorporated into the casting mold.

For optimal functioning of the system, the highest possible radiation intensity during curing of the UV varnish 3 is advantageous, since this allows a high process speed and/or a low reactivity of the UV varnish 3. For this purpose, it is advantageous if the radiation of the UV sources 10 is focused with optical components in order to avoid unproductive scattered light.

All types of electromagnetic radiation that are suitable for activating the photoinitiator or starting the radical reaction through another process can be used to cure UV varnish 3. Care must be taken to ensure that the radiation is not absorbed by the roller coating 9. The feed rate of substrate 2 is 5 or 10 m/min. A good curing of the UV varnish 3 is achieved. The edge regions of the substrate 2 are of good optical quality. There is no evidence of roller unwinding, and subsequent post-curing is not absolutely necessary.

The UV varnish 3 used comprises a polyether acrylate as a reactive resin component, which enables a high-quality and lightfast varnish for indoor use. As a reactive diluent, TMPO3TA is used, which is favorable in terms of labeling. As a photoinitiator, TPO-L is used, which works very well at the wavelength of the radiation used. Airex 901W was used as defoamer, and Tego Rad 2650 as leveling agent.

The following formulation is based upon 100 T:
75 T Laromer PO 84 F (BASF)
19.5 T TMPO3TA (e.g., Miwon)
5 T TPO-L (BASF)
0.3 T Tego RAD 2650 (Evonik)
0.2 T Tego Airex 901 W (Evonik)

The formulation shown is only an example. Many other combinations are possible, depending upon the coating requirements.

### LIST OF REFERENCE NUMERALS

1. Conveyor belt
2. Substrate
3. UV varnish
4. Coating station
5. Coating roller
6. Storage container
7. Roller
8. Roller core
9. Roller coating
10. UV source
11. LED UV emitter
12. Emitter
13. LED emitter
14. Surface of 9
15. Component
16. Recess
17. Light segment
18. Line
19 Slip ring seal
20. Contact segment
21. Contact

1. Method for curing UV varnish (3), which is applied to the surface of a substrate (2), using a roller (7), characterized in that the roller core (8) thereof holds at least one UV radiation-emitting source (10), wherein the UV radiation penetrates a roller coating (9) surrounding the periphery and strikes the surface coated with the UV varnish (3).

2. Method according to claim 1, characterized in that a voltage supply of the at least one UV source (10) is position-dependent upon its orientation relative to the substrate (2).

3. Method according to claim 1, characterized in that the roller (7) is unrolled, relative to the substrate (2).

4. Method according to claim 1, characterized in that the substrate (2) is conveyed between the roller (7) and a counter roller, opposite the roller (7), or a conveyor belt (1).

5. Method according to claim 1, characterized in that the UV varnish (3) cured on the surface of the substrate (2) is subsequently deep cured using a conventional emitter.

6. Apparatus for carrying out the method according to claim 1 with a roller (7), characterized in that it comprises a central roller core (8) and a peripheral roller coating (9), wherein the roller core (8) holds a plurality of UV sources (10) distributed over the periphery, the emitted UV radiation of which penetrates the roller coating (9) permeable to UV radiation and strikes the surface of the substrate (2) coated with the UV varnish (3) in order to cure the UV varnish (3).

7. Apparatus according to claim 6, characterized in that the UV sources (10) are oriented linearly and extend across the width of the roller core (8).

8. Apparatus according to claim 7, characterized in that a plurality of UV sources (10) arranged in a row can be supplied with voltage depending upon their position relative to the substrate (2).

9. Apparatus according to claim 8, characterized in that, for the position-dependent voltage supply, either an electronic controller switches the voltage supply of certain UV sources (10) on and off depending upon signals from a position detection sensor, or current paths of the UV sources (10) arranged in a row and interconnected are connected to a contact (21) assigned to the end face of the roller (7), which contact acts upon a voltage-carrying contact segment (20) to open and close an electric circuit.

10. Apparatus according to claim 6, characterized in that a row of UV sources (10) extending across the width of the roller core (8) is integrated into a light segment (17) which can be exchangeably attached to the roller core (8).

11. Apparatus according to claim 6, characterized in that a cooling device is associated with the roller (7).

12. Apparatus according to claim 6, characterized in that the roller coating (9) of the roller (7) is elastic.

13. Apparatus according to claim 6, characterized in that the roller (7) is assigned a counter roller or a conveyor belt (1), wherein the roller (7) and/or the counter roller and/or the conveyor belt (1) are adjustable relative to one another, and the substrate (2) coated with the UV varnish (3) can be conveyed between the roller (7) and the counter roller or the conveyor belt.

14. Apparatus according to claim 6, characterized in that the UV source (10) is designed as an LED UV emitter (11).
